(19) United States
(12) Patent Application Publication
(10) Pub. No.: US 2015/0271242 A1
(43) Pub. Date: Sep. 24, 2015

(54) Method and Apparatus for Acquiring Streaming Media Buffer Parameter

(71) Applicant: Huawei Technologies Co., Ltd., Shenzhen (CN)

(72) Inventors: Hua Jiang, Plano, TX (US); Qingpo Tong, Xi'an (CN)

(21) Appl. No.: 14/729,972

(22) Filed: Jun. 3, 2015

Related U.S. Application Data
(63) Continuation of application No. PCT/CN2013/082028, filed on Aug. 22, 2013.

(30) Foreign Application Priority Data
Dec. 3, 2012 (CN) 201210509110.1

(51) Int. Cl. H04L 29/06; H04L 29/08; G06F 17/30

(52) U.S. Cl. CPC H04L 65/607; H04L 65/608; G06F 17/3082; H04L 67/10

(57) ABSTRACT

The present invention relates to a method for acquiring a streaming media buffer parameter, including acquiring video packets of a media stream, calculating throughput of the video packets in a transmission process, and calculating the streaming media buffer parameter according to a value of the throughput and acquired video duration.

This application is a continuation of International Application No. PCT/CN2013/082028, filed on Aug. 22, 2013, which claims priority to Chinese Patent Application No. 201210509110.1, filed on Dec. 3, 2012, both of which are hereby incorporated by reference in their entireties.

### TECHNICAL FIELD

The present invention relates to the communications field, and in particular, to a method and an apparatus for acquiring a streaming media buffer parameter.

### BACKGROUND

Streaming media is a continuous audio/video data stream that is transmitted and played on a network according to a streaming technology. The streaming technology refers to that a server parses, in a specific compression manner, an entire multimedia file into multiple compressed packages, and transmits the multiple compressed packages to a user in a sequence or in real time by means of an IP address, and a client creates a buffer to receive the compressed packages.

A streaming media system refers to a system that can provide a streaming media service for an end user by using a streaming technology. A basic architecture of a streaming media system includes three layers: a streaming media production and server layer that provides collection, coding, and play of content of live/recorded/on-demand streaming media by using a device that is made for a play system, offers a program by using a Web server, and provides content management, system management, and statistical analysis by using a background management system; a network layer that is a layer for ensuring service quality of the streaming media system and for providing a service with the best quality for the end user; and a client layer, in which a user terminal accesses a network, completes demultiplexing, decoding, synchronization, and the like of a video and audio, and then plays the video and the audio.

An ultimate objective of the streaming media system is to provide a streaming media service for a user, that is, to provide the user with perceived quality that can satisfy the user. A quality perception indicator QoE of the user can relatively accurately reflect a satisfaction degree of an end user on the streaming media service, such as resolution and play fluency.

To acquire a relatively accurate QoE indicator, a relatively accurate QoE relevant parameter needs to be acquired first. A buffer parameter affects user experience on HTTP streaming media. In a same network situation, if a cache is relatively large, relatively smooth play can be provided, and it is not prone to a pause or an interruption; however, a startup delay and a restore delay are increased, where delay is an important assessment indicator of user experience, and if a delay is greater than a threshold, a user may give up watching; and if the cache is relatively small, a capability of inhibiting fluctuations is relatively poor, that is, when network bandwidth fluctuates and a play speed is greater than a download speed, after play of buffered content is finished, relatively frequent pauses and even interruptions are caused. In conclusion, a client buffer parameter affects four indicators of a QoE relevant indicator, that is, play waiting duration, the number of pauses, pause duration, and a play interruption rate. Therefore, a relatively accurate client buffer parameter needs to be acquired.

In the prior art, to acquire a client buffer parameter, a feedback is performed in a manner of feeding back a set buffer parameter by a client; and specifically, an agent (Terminal Agent) is installed on a user terminal, and the agent periodically reports, to a QoE platform, measurement parameters related to QoE and video quality that are in a TCP/IP layer and of a user, which however, is difficult and cannot be implemented in the prior art, and a relatively precise buffer parameter cannot be acquired.

### SUMMARY

In view of this, embodiments of the present invention provide a method and an apparatus for acquiring a streaming media buffer parameter, so as to resolve a problem that it is difficult to acquire a streaming media buffer parameter, and improve precision of the acquired streaming media buffer parameter.

According to a first aspect, an embodiment of the present invention provides a method for acquiring a streaming media buffer parameter, including acquiring video packets of a media stream, and calculating throughput of the video packets in a transmission process; and calculating the streaming media buffer parameter according to a value of the throughput and acquired video duration.

In a first possible implementation manner of the first aspect, when packet headers of the video packets include timestamps, before the calculating the streaming media buffer parameter according to a value of the throughput and acquired video duration, the method further includes: obtaining, by parsing, a difference between times recorded by the timestamps in the packet headers of the video packets, and acquiring a difference between times recorded by a timestamp in a transmission control protocol TCP acknowledgement packet, where the differences between the times separately indicate differences between times that are in different timestamps and correspond to the video packets from the first to the last.

With reference to the first aspect or the first possible implementation manner of the first aspect, after the obtaining, by parsing, a difference between times recorded by the timestamps in the packet headers of the video packets, and acquiring a difference between times recorded by a timestamp in a transmission control protocol TCP acknowledgement packet, the method further includes: when the difference between the times recorded in the TCP acknowledgement packet is greater than the difference between the times recorded in the packet headers of the video packets, determining that a pause occurs on a player during play.

According to a second aspect, an embodiment of the present invention provides an apparatus for acquiring a streaming media buffer parameter, including: an acquiring unit, configured to acquire video packets of a media stream; and a calculating unit, configured to calculate throughput of the video packets in a transmission process, and calculate the streaming media buffer parameter according to a value of the throughput and acquired video duration.

In a first possible implementation manner of the second aspect, when packet headers of the video packets include timestamps, the apparatus further includes a parsing unit, configured to obtain, by parsing, a difference between times recorded by the timestamps in the packet headers of the video packets, and acquire a difference between times recorded by a timestamp in a transmission control protocol TCP acknowledgement packet, where the differences between the times separately indicate differences between times that are in different timestamps and correspond to the video packets from the first to the last.

With reference to the second aspect or the first possible implementation manner of the second aspect, the apparatus further includes a determining unit, configured to: when the difference between the times recorded in the TCP acknowledgement packet is greater than the difference between the times recorded in the packet headers of the video packets, determine that a pause occurs on a player during play.

According to the method and apparatus provided in the embodiments of the present invention, video packets of a media stream are acquired, and throughput of the video packets in a transmission process is calculated; and a streaming media buffer parameter is calculated according to a value of the throughput and acquired video duration, thereby resolving a problem that it is difficult to acquire a streaming media buffer parameter, and improving precision of the acquired streaming media buffer parameter.

### BRIEF DESCRIPTION OF DRAWINGS

FIG. 1 is an architecture diagram of an application environment according to an embodiment of the present invention;

FIG. 2 is a flowchart according to Embodiment 1 of the present invention;

FIG. 3 is a flowchart according to Embodiment 2 of the present invention;

FIG. 4 is a schematic diagram of determining a time difference according to Embodiment 2 of the present invention;

FIG. 5 is a schematic diagram of a TCP receive buffer and a player buffer according to Embodiment 2 of the present invention;

FIG. 6 is a composition diagram of an apparatus according to Embodiment 3 of the present invention; and

FIG. 7 is a hardware architecture diagram of an apparatus according to Embodiment 3 of the present invention.

### DETAILED DESCRIPTION OF THE ILLUSTRATIVE EMBODIMENTS

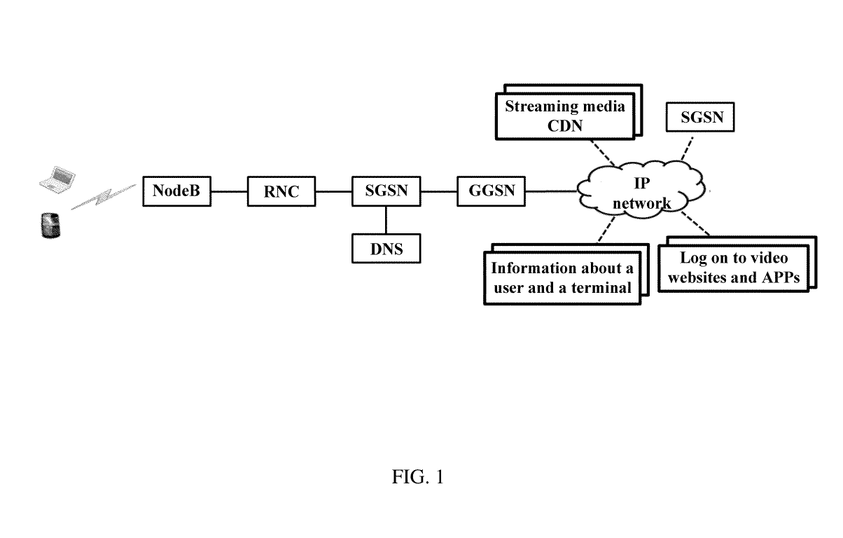

FIG. 1 shows a basic streaming media service system. Generally, a QoE assessment system may be deployed on a network interface, such as an Iu-PS interface (between an RNC and an SGSN) or a Gn interface (between an SGSN and a GGSN); and a buffer parameter is set by a user terminal.

The foregoing method disclosed in the embodiments of the present invention may be implemented in a central processing unit, in other words, may be implemented by a central processing unit. The central processing unit may be an integrated circuit chip and has a signal processing capability. In an implementation process, steps of the foregoing method may be completed by using an integrated logic circuit of hardware in the central processing unit or by using instructions in software forms. The foregoing central processing unit may be a general purpose processor, a digital signal processor (DSP), an application specific integrated circuit (ASIC), a field programmable gate array (FPGA), or another programmable logic device, a discrete gate or a transistor logic device, or a discrete hardware component, and can implement or execute the method, the steps, and the logical block diagrams that are disclosed in the embodiments of the present invention. The general purpose processor may be a microprocessor, or the processor may be any conventional processor, or the like. The steps of the method disclosed with reference to the embodiments of the present invention may be directly executed by a hardware processor, or may be executed by a combination of hardware and software modules in a processor. A software module may be located in a storage medium that is mature in the art, such as a random access memory, a flash memory, a read-only memory, a programmable read-only memory, an electrically erasable programmable memory, or a register. The storage medium is located in a memory; and the central processing unit reads information in the memory, and completes the steps of the foregoing method by combining with hardware of the central processing unit.

### Embodiment 1

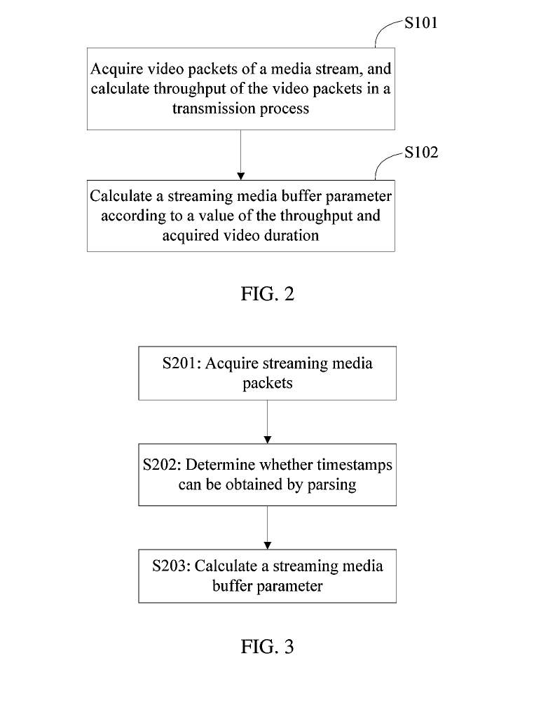

As shown in FIG. 2, in the embodiment of the present invention, a process of acquiring a streaming media buffer parameter is as follows.

S101: Acquire video packets of a media stream, and calculate throughput of the video packets in a transmission process.

In this embodiment, an execution body is a network quality assessment platform located on an IP network side.

S102: Calculate a streaming media buffer parameter according to a value of the throughput and acquired video duration.

When packet headers of the video packets include timestamps, a difference between time recorded by the timestamps in the packet headers of the video packets needs to be obtained by parsing, and a difference between times recorded by a timestamp in a transmission control protocol TCP acknowledgement packet needs to be acquired, where the differences between the times separately indicate differences between times that are in different timestamps and correspond to the video packets from the first to the last. When the difference between the times recorded in the TCP acknowledgement packet is greater than the difference between the times recorded in the packet headers of the video packets, it is determined that a pause occurs on a player during play.

A specific method for calculating the streaming media buffer parameter is as follows: calculating a startup delay according to the throughput and an average play rate, and calculating, according to the startup delay, a throughput rate corresponding to the startup delay, where the streaming media buffer parameter is a product of the throughput rate and the startup delay.

Alternatively, if packet headers of the video packets do not include timestamps, and when a size of available space of the TCP buffer is equal to a preset threshold, it is determined that a pause occurs on the player during play.

A specific method for calculating the streaming media buffer parameter is as follows: calculating a startup delay according to the throughput and an average play rate, and calculating, according to the startup delay, a throughput rate corresponding to the startup delay, where the streaming media buffer parameter is a product of the throughput rate and the startup delay.

According to the method provided in the embodiment of the present invention, video packets of a media stream are acquired, and throughput of the video packets in a transmission process is calculated, and a streaming media buffer parameter is calculated according to a value of the throughput and acquired video duration, thereby resolving a problem that it is difficult to acquire a streaming media buffer parameter, and improving precision of the acquired streaming media buffer parameter.

### Embodiment 2

FIG. 3 is a flowchart according to an embodiment of the present invention. As shown in FIG. 3, a process in the embodiment of the present invention is as follows.

S201: Acquire streaming media packets.

A network quality assessment platform acquires, by communicating with a streaming media server, the streaming media packets sent by the server.

S202: Determine whether timestamps can be obtained by parsing.

The network quality assessment platform parses the received streaming media packets, and determines whether the timestamps can be obtained by parsing.

If there are play timestamps of a video in video protocol packet headers, or timestamps set in audio content for sound-image synchronization, these time points indicated in the timestamps are used for stamping content in each packet with a corresponding time point. For example, an arrival time of the first packet is T1, and an arrival time of the n^{th} packet is Tn.

Because the streaming media packets are transmitted by using the TCP protocol, the network quality assessment platform may obtain, from a timestamp of a received TCP acknowledgement ACK packet, times at which the TCP packet is received on a terminal. For example, a reception time of the first ACK packet is D1, and a reception time of the n^{th} acknowledgement (ACK) packet is Dn.

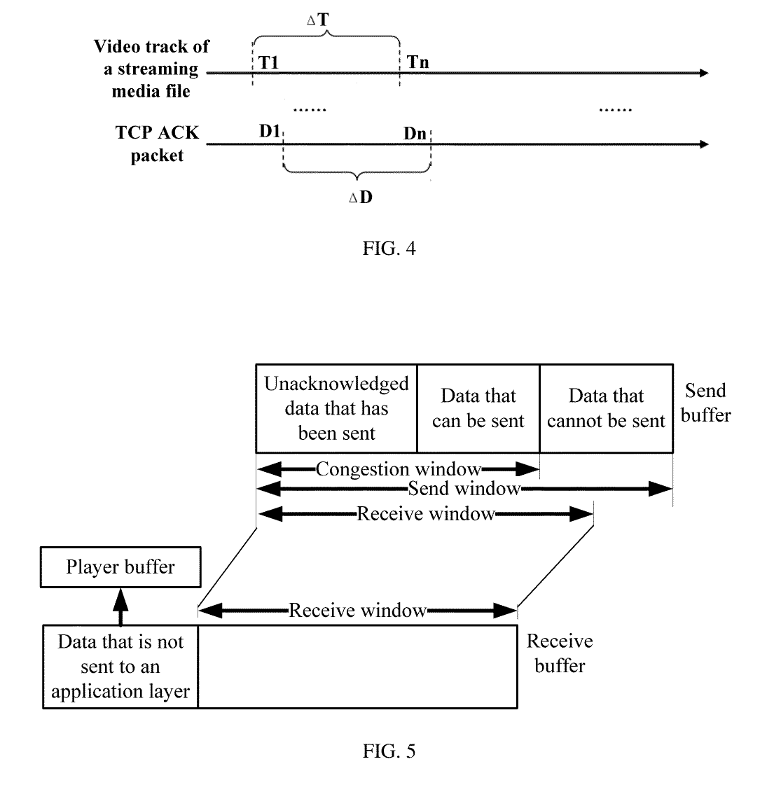

As shown in FIG. 4, a correspondence in terms of time difference exists between a video track timestamp and a TCP ACK packet timestamp. That is, for a video time N, it is assumed that a frame corresponding to this time is Frame N, for this frame, a video track timestamp is Tn, and a timestamp of a TCP ACK packet at which the frame arrives is Dn; if no pause occurs, a difference between times in the video track is equal to a difference between times in the TCP ACK packet, that is, Dn−D1=Tn−T1; and if an arrival time is later than a time required for continuous play, a pause occurs, that is, when Dn−D1>Tn−T1, a pause occurs.

Some video protocols have no requirement on a play time, or due to content encryption, timestamps of video packets cannot be obtained. In this case, an occurrence of a pause may be determined according to a receive window (Receive Window) of an ACK packet.

When the Receive Window of the ACK packet is no longer periodically fluctuated but exceeds a preset value of a receive cache, it is determined that a pause occurs. As shown in FIG. 5, a principle thereof is as follows: in a normal play process, a receive window size (Receive Window Size) of a TCP ACK packet reflects a size of available space of a receive buffer, a TCP slow-start mechanism, a TCP congestion control mechanism, and a TCP fast recovery and repeat mechanism enable a throughput rate to periodically fluctuate, that is, enable the receive window size to periodically fluctuate. A size of available space of a client TCP receive buffer is reflected in the Receive Window of the ACK packet. After a pause occurs, a player buffer is empty. A player waits and sends data in the TCP receive buffer to the player buffer at any time. At this time, the available quantity of the client TCP receive buffer is close to a maximum value. Therefore, the network quality assessment platform sets a preset value, where the preset value may be set to a value close to the maximum value, and when the value is exceeded, it is determined that a pause occurs.

S203: Calculate a streaming media buffer parameter.

Before calculating the streaming media buffer parameter, parameters necessary for calculation need to be acquired, including: TCP throughput, a TCP average download rate, the receive window size of the TCP ACK packet, and the timestamp Dn of the ACK packet. The timestamp of the TCP ACK packet may be directly obtained by data parsing, and for the TCP throughput and the TCP average download rate, a TCP throughput model is established, and parameters obtained by data parsing, such as a TCP RTT, a TCP repeat rate, and a receive window, are input into the TCP throughput model to obtain functions of time t: TCP throughput V(t) and TCP average download rate R(t).

A buffer parameter is calculated in two scenarios: a scenario with a play pause and a scenario with no play pause. The following separately describes calculation of the buffer parameter in the two different scenarios.

Calculation of a buffer parameter in a scenario with a play pause is as follows:

Assuming that a start time of the play pause during the is F, F is defined as duration from the beginning of playing to an occurrence of the pause, and accumulated TCP throughput at a time F is V(F), where:

inferred effective play time G is:

G=V(F)/K;

an inferred startup delay I is:

I=F−G (unit:second); and

an inferred player cache B is:

B=R(I)×I (unit:Bytes).

Calculation of the caching parameter in a scenario in which no pause occurs during play is as follows.

When no pause occurs in a play process, the number of pauses is equal to 0, a pause delay is equal to 0, and then a startup delay I is:

I=TCP duration−total TCP throughput V/average playback rate K; and

if video duration can be obtained, by parsing, from a packet header of a video packet,

I=TCP duration−video duration; and then

a player cache is:

B=R(I)×I (unit:Bytes).

According to the method provided in the embodiment of the present invention, video packets of a media stream are acquired, and throughput of the video packets in a transmission process is calculated; and a streaming media buffer parameter is calculated according to a value of the throughput and acquired video duration, thereby resolving a problem that it is difficult to acquire a streaming media buffer parameter, and improving precision of the acquired streaming media buffer parameter.

### Embodiment 3

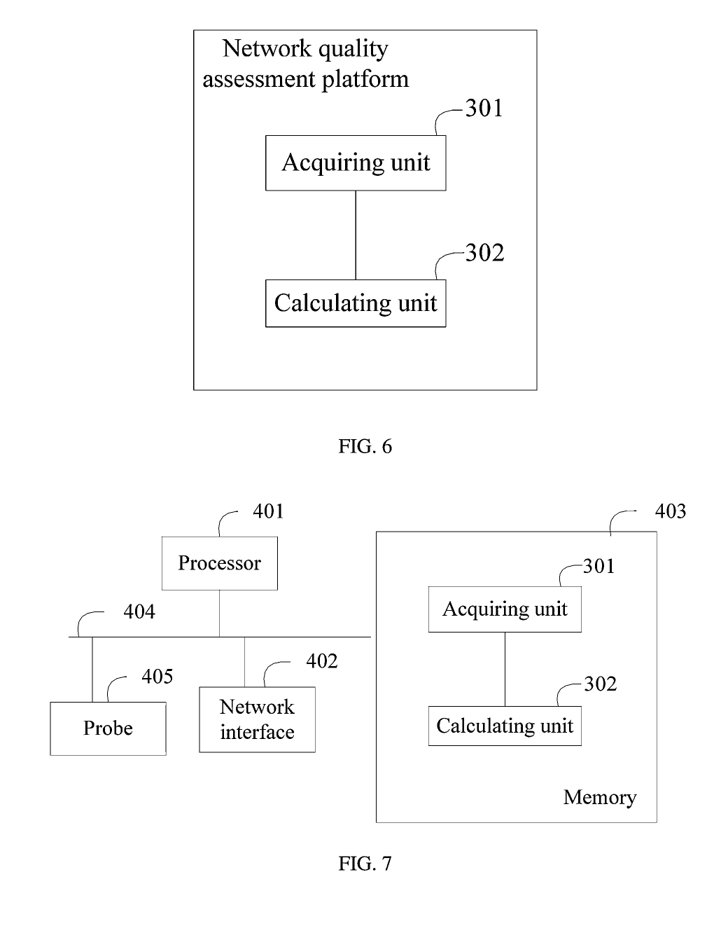

FIG. 6 is a structural composition diagram of a CSFB server. As shown in FIG. 6, the CSFB server includes an acquiring unit 301, configured to acquire video packets of a media stream. In this embodiment, an execution body is a network quality assessment platform on an IP network side. A calculating unit 302 is configured to calculate throughput of the video packets in a transmission process, and calculate a streaming media buffer parameter according to a value of the throughput and acquired video duration.

When packet headers of the video packets include timestamps, the calculating unit 302 needs to obtain, by parsing, a difference between times recorded by the timestamps in the packet headers of the video packets, and acquire a difference between times recorded by a timestamp in a transmission control protocol TCP acknowledgement packet, where the differences between the times separately indicate differences between times that are in different timestamps and correspond to the video packets from the first to the last. When the difference between the times recorded in the TCP acknowledgement packet is greater than the difference between the times recorded in the packet headers of the video packets, it is determined that a pause occurs on a player during play.

A specific method for calculating the streaming media buffer parameter by the calculating unit 302 is as follows: calculating a startup delay according to the throughput and an average play rate, and calculating, according to the startup delay, a throughput rate corresponding to the startup delay, where the streaming media buffer parameter is a product of the throughput rate and the startup delay.

Alternatively, if packet headers of the video packets do not include timestamps, and when a size of available space of the TCP buffer is equal to a preset threshold, it is determined that a pause occurs on the player during play.

A specific method for calculating the streaming media buffer parameter is as follows: calculating a startup delay according to the throughput and an average play rate, and calculating, according to the startup delay, a throughput rate corresponding to the startup delay, where the streaming media buffer parameter is a product of the throughput rate and the startup delay.

According to the apparatus provided in the embodiment of the present invention, an acquiring unit acquires video packets of a media stream; and a calculating unit calculates throughput of the video packets in a transmission process, and calculates a streaming media buffer parameter according to a value of the throughput and acquired video duration, thereby resolving a problem that it is difficult to acquire a streaming media buffer parameter, and improving precision of the acquired streaming media buffer parameter.

FIG. 7 shows a hardware architecture diagram of a network quality assessment platform provided in another embodiment of the present invention. The network quality assessment platform includes at least one processor 401 (such as, a CPU), at least one network interface 402 or another communications interface, a memory 403, at least one communications bus 404 for implementing communication connection between these apparatuses, and a probe 405 for collecting data. The processor 401 is configured to execute an executable module, such as a computer program, stored in the memory 403. The memory 403 may include a high-speed random access memory (RAM), and may also include a non-volatile memory, such as at least one magnetic disk memory. The at least one network interface 402 (which may be wired or wireless) may implement a communication connection between a system gateway and at least one other network element by using the Internet, a wide area network, a local area network, a metropolitan area network, or the like.

In some implementation manners, the memory 403 stores a program instruction, and the program instruction may be executed by the processor 401, where the program instructions include instructions of the acquiring unit 301 and the calculation unit 302. For specific implementation of the units, reference may be made to corresponding units disclosed in FIG. 6, and details are not described herein again.

With descriptions of the foregoing embodiments, a person skilled in the art may clearly understand that the present invention may be implemented by hardware, firmware or a combination thereof. When the present invention is implemented by software, the foregoing functions may be stored in a computer-readable medium or transmitted as one or more instructions or code in the computer-readable medium. The computer-readable medium includes a computer storage medium and a communications medium, where the communications medium includes any medium that enables a computer program to be transmitted from one place to another. The storage medium may be any available medium accessible to a computer. The following provides an example but does not impose a limitation: The computer-readable medium may include a RAM, a ROM, an EEPROM, a CD-ROM, or another optical disc storage or disk storage medium, or another magnetic storage device, or any other medium that can carry or store expected program code in a form of an instruction or a data structure and can be accessed by a computer. In addition, any connection may be appropriately defined as a computer-readable medium. For example, if software is transmitted from a website, a server or another remote source by using a coaxial cable, an optical fiber/cable, a twisted pair, a digital subscriber line (DSL) or wireless technologies such as infrared ray, radio and microwave, the coaxial cable, optical fiber/cable, twisted pair, DSL, or wireless technologies such as infrared ray, radio and microwave are included in fixation of a medium to which they belong. For example, a disk (Disk) and disc (disc) used in the present invention includes a compact disc CD, a laser disc, an optical disc, a digital versatile disc (DVD), a floppy disk and a Blu-ray disc, where the disk generally copies data by a magnetic means, and the disc copies data optically by a laser means. The foregoing combination should also be included in the protection scope of the computer-readable medium.

In summary, what is described above is merely exemplary embodiments of the technical solutions of the present invention, but is not intended to limit the protection scope of the present invention. Any modification, equivalent replacement, or improvement made without departing from the spirit and principle of the present invention shall fall within the protection scope of the present invention.

What is claimed is:

1. A method for acquiring a streaming media buffer parameter, comprising:
acquiring video packets of a media stream;
calculating throughput of the video packets in a transmission process; and
calculating the streaming media buffer parameter according to a value of the throughput and acquired video duration.

2. The method according to claim 1, wherein packet headers of the video packets comprise timestamps, the method further comprising:
obtaining, by parsing, a difference between times recorded by the timestamps in the packet headers of the video packets; and
acquiring a difference between times recorded by a timestamp in a transmission control protocol TCP acknowledgement packet;
wherein the differences between the times recorded each separately indicate differences between times that are in different timestamps and correspond to the video packets from the first to the last.

3. The method according to claim 2, the method further comprising:
determining that a pause occurs on a player during play when the difference between the times recorded in the TCP acknowledgement packets is greater than the difference between the times recorded in the packet headers of the video packets.

4. The method according to claim 2, wherein calculating the streaming media buffer parameter according to a value of the throughput and acquired video duration comprises:
calculating a startup delay according to the throughput and an average play rate; and
calculating, according to the startup delay, a throughput rate corresponding to the startup delay, wherein the streaming media buffer parameter is a product of the throughput rate and the startup delay.

5. The method according to claim 1, wherein each packet header of the video packets is absent a timestamp, the method further comprising:
determining that a pause occurs on a player during play when a size of available space of a TCP buffer is equal to a preset threshold.

6. An apparatus for acquiring a streaming media buffer parameter, the apparatus comprising:
an acquiring unit, configured to acquire video packets of a media stream; and
a calculating unit, configured to calculate throughput of the video packets in a transmission process and calculate the streaming media buffer parameter according to a value of the throughput and acquired video duration.

7. The apparatus according to claim 6, wherein packet headers of the video packets comprise timestamps, the apparatus further comprising a parsing unit, configured to obtain, by parsing, a difference between times recorded by the timestamps in the packet headers of the video packets, and to acquire a difference between times recorded by a timestamp in a transmission control protocol TCP acknowledgement packet, wherein the differences between the times recorded each separately indicate differences between times that are in different timestamps and correspond to the video packets from the first to the last.

8. The apparatus according to claim 7, wherein the apparatus further comprises a determining unit, configured to determine that a pause occurs on a player during play when the difference between the times recorded in the TCP acknowledgement packet is greater than the difference between the times recorded in the packet headers of the video packets.

9. The apparatus according to claim 6, wherein packet headers of the video packets are absent timestamps, the apparatus further comprising a determining unit, configured to determine that a pause occurs on a player during play when a size of available space of a TCP buffer is equal to a preset threshold.

10. An apparatus for acquiring a streaming media buffer parameter, the apparatus comprising:
a processor; and
a computer-readable storage medium storing a program to be executed by the processor, the program including instructions for:
acquiring video packets of a media stream;
calculating throughput of the video packets in a transmission process; and
calculating the streaming media buffer parameter according to a value of the throughput and acquired video duration.

11. The apparatus according to claim 10, wherein packet headers of the video packets comprise timestamps and wherein the program includes further instructions for:
parsing to obtain a difference between times recorded by the timestamps in the packet headers of the video packets; and
acquiring a difference between times recorded by a timestamp in a transmission control protocol TCP acknowledgement packet, wherein the differences between the times recorded each separately indicate differences between times that are in different timestamps and correspond to the video packets from the first to the last.

12. The apparatus according to claim 11, wherein the program includes further instructions for determining that a pause occurs on a player during play when the difference between the times recorded in the TCP acknowledgement packet is greater than the difference between the times recorded in the packet headers of the video packets.

13. The apparatus according to claim 10, wherein each packet header of the video packets is absent a timestamp, wherein the program includes further instructions for determining that a pause occurs on a player during play when a size of available space of a TCP buffer is equal to a preset threshold.
